(19) United States
(12) Patent Application Publication
(10) Pub. No.: US 2007/0099702 A1
(43) Pub. Date: May 3, 2007

(54) Network-based gaming system

(75) Inventor: Steven J. Tupper, Southampton (GB)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/571,824

(22) PCT Filed: Sep. 9, 2004
(86) PCT No.: PCT/IB04/51721

§ 371 Date: Mar. 15, 2006

(30) Foreign Application Priority Data
Sep. 20, 2003 (GB) 0322045.6

(51) Int. Cl. A63F 9/24; G06F 19/00

(52) U.S. Cl. 463/42; 463/41

(57) ABSTRACT

Terminals (20, 22, 24, 30, 40) of players connect with a host (10) of a gaming application via a network (50). Terminals can be of different types and have different capabilities. The host (10) comprises processing means for supporting a gaming application and an interface (13, FIG. 4). The interface (13) determines the capabilities of a terminal being used by a player and provides the terminal with a range of interaction with the gaming application which is matched to the determined capabilities of the terminal. The gaming application can be a multi-player gaming application such as a massively multiplayer online role playing game (MMORPG). Terminals having limited capabilities are provided with access to limited gaming functions, such as management functions. Two terminals may simultaneously access the same player's data, with a terminal of lower capabilities being used by a co-pilot.

This invention relates to games which are played across a network and to the equipment and software which supports such a gaming system.

Modem gaming has evolved since the days of simple single or two-player high score games which were played on stand-alone gaming terminals. There is now increasing interest in games which are played across a network, usually against other players. One type of game which is becoming increasingly popular is a multi-player role playing game in which large numbers of players—often hundreds or thousands of players—control characters who simultaneously ‘live’ in the same fantasy world. Each player uses a gaming platform which is linked to a host of the game via a network, such as the Internet. This type of game is called a Massively Multiplayer Online Role Playing Game (MMORPG). Current games of this genre include EverQuest™.

Multi-player games of this type generally require players to use a high-performance gaming platform such as a dedicated gaming console or multimedia personal computer (PC) in order to fully participate in the gaming environment. Generally, this requires a high performance processor to render three dimensional graphical environments in which the players' characters participate and a high quality display to present them to a player. Players also require a broadband connection between their terminal and the gaming host to deliver large quantities of data, such as vectors indicating the movement of characters in the environment. Multi-player gaming of this type can become obsessive, with players spending many hours online at a time. Players would like to spend as much time as possible participating in their online quests but the need to use a high performance gaming platform and broadband connection limits the amount of time that a player can devote to this type of gaming.

The present invention seeks to provide players with increased access to the gaming environment.

Accordingly, a first aspect of the present invention provides an interface for a host of a gaming system in which terminals of players connect with the host via a network, the host comprising processing means for supporting a gaming application, and wherein the interface is arranged to:

determine the capabilities of a terminal being used by a player; and,

provide the terminal with a range of interaction with the gaming application according to the determined capabilities of the terminal.

It has been realised that while players generally require a high-performance gaming platform in order to fully participate in a game, there is a range of useful functions which can be performed by a player without this high-performance platform. The interface allows players to use terminals which differ in their capabilities, with the range of gaming functions available to a player varying according to the capabilities of the terminal that a player uses. In this way, players can perform certain functions of a game, such as management activities of a role-playing game, whilst they are away from their main gaming platform and only have access to a terminal with more restricted capabilities.

Preferably, the interface determines the capabilities of a terminal by issuing a request, via the network, for information about the capabilities of the terminal. The terminal can respond by providing details of the individual features (display, processor, memory, user input, audio, network connection), a profile representative of the type of terminal, the software version that the terminal is running, or by providing benchmarking results. This information can be used to determine the capabilities of the terminal and thus the gaming functions which can be supported by the terminal.

Preferably, the interface is arranged to store the capabilities of a terminal for use during future occasions that the terminal registers with the host.

The gaming application can be a multi-player gaming application in which terminals of a plurality of players are simultaneously interconnected via the network, such as a role-playing game, although the invention is not limited to use with such games.

Preferably the interface is arranged to allow a first terminal and a second terminal to simultaneously access a single players information. This allows a second player to use a second terminal which may be used, for example, by a helper or co-pilot while the main player uses their main terminal. The second terminal can have lower capabilities than the first terminal and the interface distributes gaming functions between the first and second terminals according to their capabilities. For a role playing game, the host can assign management functions to the second terminal while character movement functions are assigned to the main terminal.

The functionality described here can be implemented in software, hardware or a combination of these. Accordingly, another aspect of the invention provides software for controlling operation of an interface of a host of a gaming system in which terminals of players connect with the host via a network, the host comprising processing means for supporting a gaming application, the software being arranged to cause a processing entity of the host to perform the functions of: determining the capabilities of a terminal being used by a player; and providing the terminal with a range of interaction with the gaming application according to the determined capabilities of the terminal.

It will be appreciated that software may be installed on the host at any point during the life of the equipment. The software may be stored on an electronic memory device, hard disk, optical disk or other machine-readable storage medium. The software may be delivered as a computer program product on a machine-readable carrier or it may be downloaded directly to the host or terminal via a network connection.

Further aspects of the invention provide a host for a gaming system, a gaming system, a method of providing a gaming service to a player in a gaming system and software for use at a terminal.

Embodiments of the present invention will now be described, by way of example only, with reference to the accompanying drawings, in which:

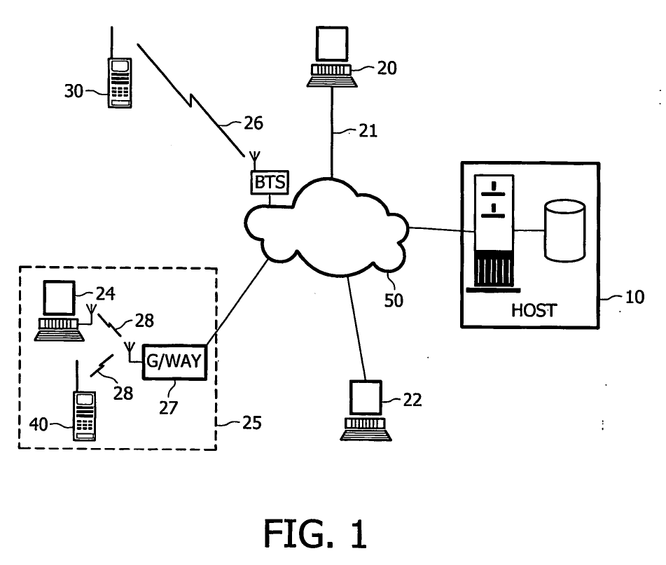

FIG. 1 shows a network for supporting multi-player gaming;

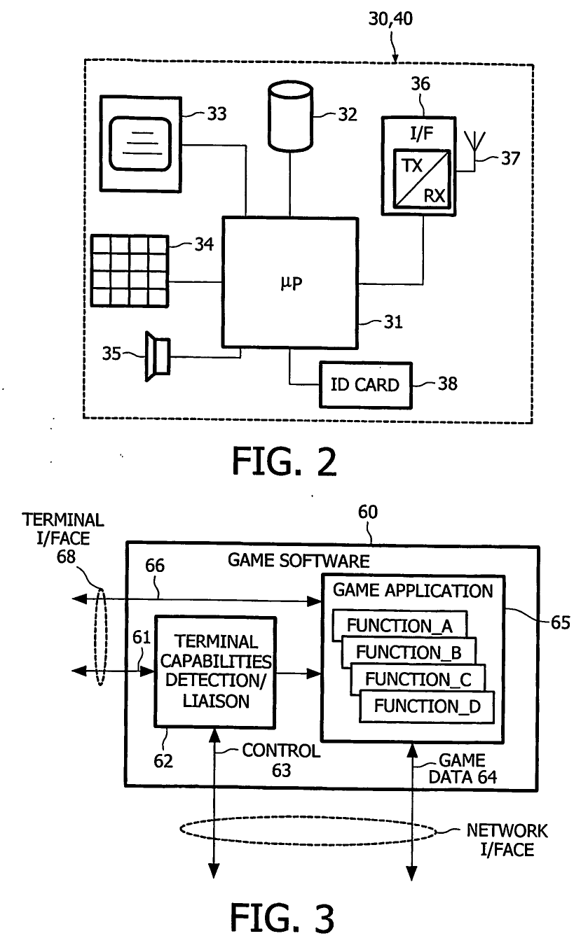

FIG. 2 schematically shows a terminal which may be used to access certain gaming functions in accordance with this invention;

FIG. 3 shows the functional blocks of the game software for a terminal;

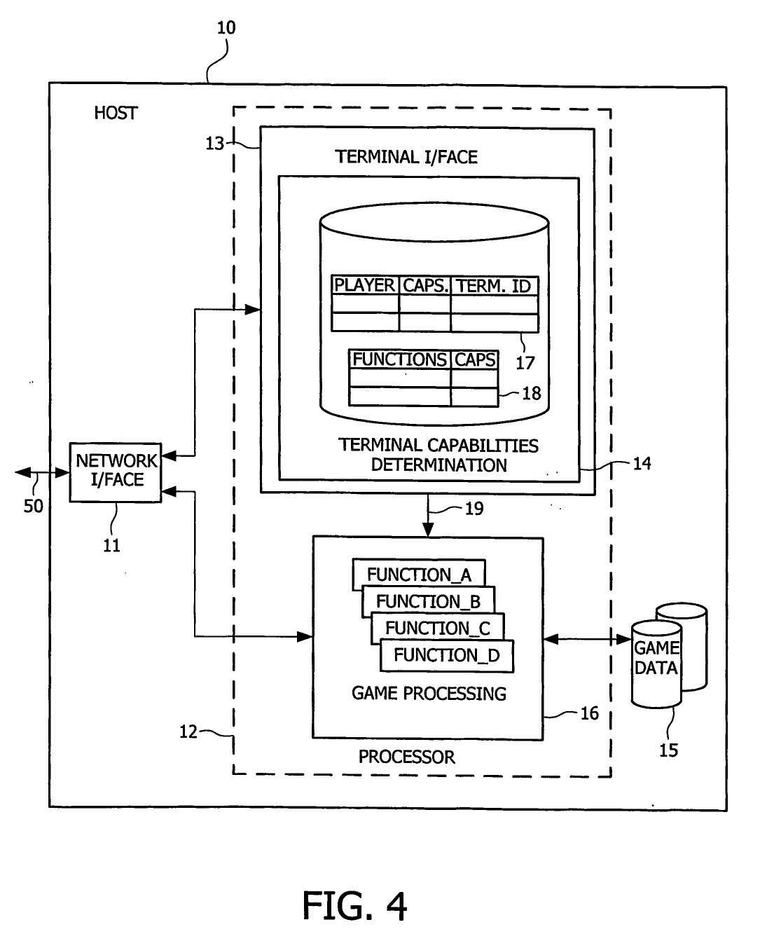

FIG. 4 schematically shows the host of FIG. 1 in more detail;

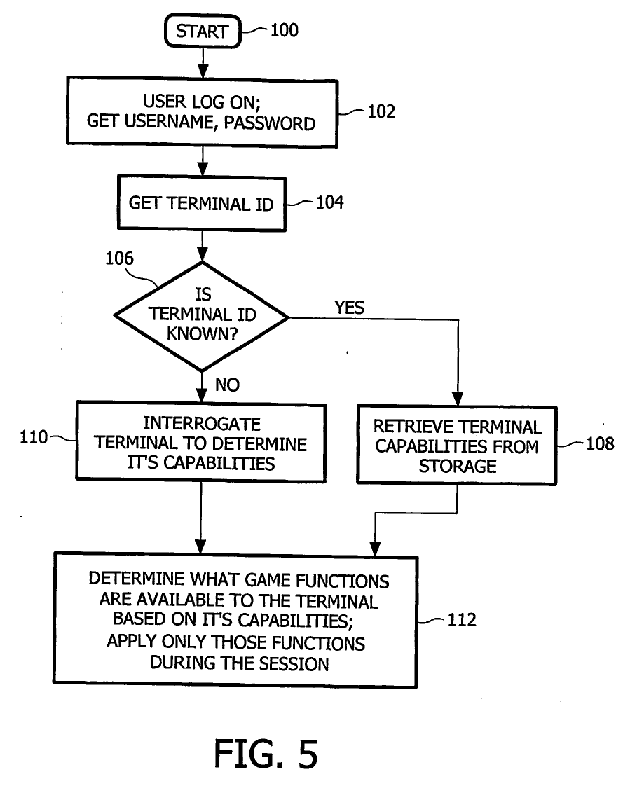

FIG. 5 shows a flow diagram of a registration process for a terminal;

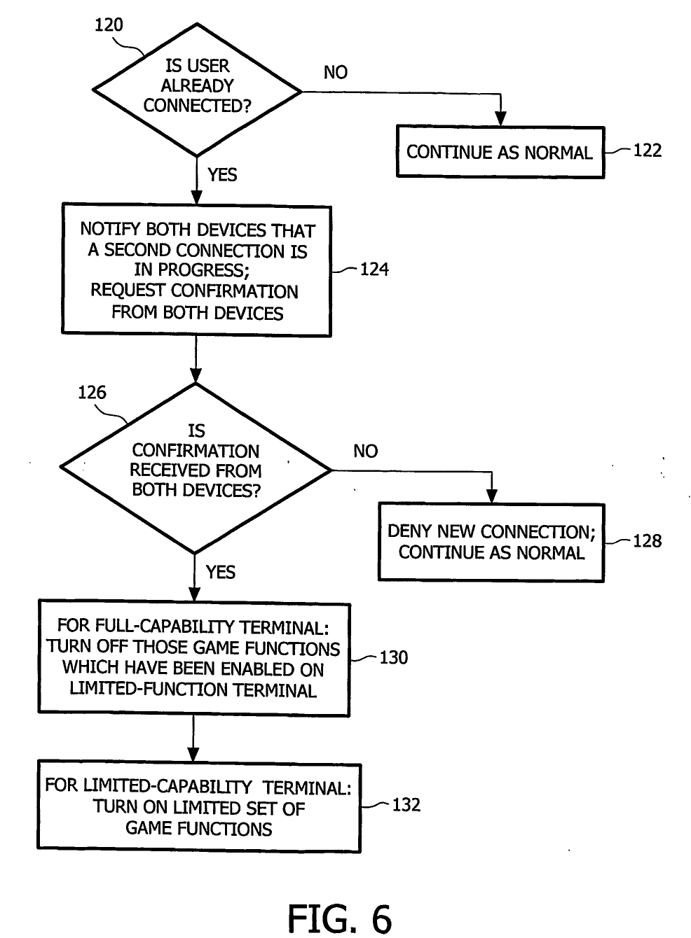

FIG. 6 shows a flow diagram of a registration process for a second terminal.

FIG. 1 shows an example network for supporting a multi-player gaming environment. The network in FIG. 1 is a client-server network having a host 10 with a server which supports a gaming environment. Terminals 20, 22, 24 represent the primary terminals of players which communicate with the host 10 via network 50. Typically, network 50 is the Internet, with the connection between individual terminals 20, 22, 24 and the host 10 being formed by a broadband connection 21 between the terminal and an Internet Service Provider (ISP) and an Internet Protocol (IP) transmission path across one or more carrier networks. However, network 50 could equally be a local area network (LAN), Wide Area Network (WAN) or some hybrid combination of network types and the precise form is unimportant to the invention. Terminals 20, 22, 24 are gaming platforms, such as dedicated gaming consoles (e.g. Microsoft Xbox™) or multimedia personal computers (PCs), which can support the full functionality of a game. Each terminal runs software which supports the gaming application and allows communication over network 50.

Massively multiplayer online role playing games (MMORPGs) usually have two elements to them. The first element concentrates on the player's character movement; fighting other characters, navigating and interacting with the environment of the game world and carrying out quests and missions. This first element is the main focus of the game and requires a gaming platform that is capable of impressive graphics and intensive processing. The second element present in these games is the management of the player's character. The management usually comprises such functions as: managing an inventory, equipping or using objects, viewing a map or planning a route, viewing details of quests or in-game documents, assigning experience points and viewing/altering character statistics and attributes, trading with other characters, chatting with other players and planning a mission with fellow party members. Although these management activities are considered secondary to the first element, much time is spent in these sorts of activities. This second element is also currently performed on the player's terminal.

FIG. 1 also shows a terminal 30 which is a terminal with lower capabilities than terminals 20, 22, 24. It will be assumed that terminal 30 belongs to the player who normally uses terminal 20. Typically, terminal 30 is a mobile phone, personal digital assistant (PDA) or similar portable terminal with a network connection and does not need to be a device which is normally intended for gaming. FIG. 2 shows the typical features of a terminal 30. Terminal 30 comprises a controller 31 for controlling operation of the device, a user interface with a display 33 and input device 34. User outputs include an audio speaker 35. A network interface 36 comprises a suitable codec, modulation stage, a transmitter/receiver and antenna 37 to allow the portable terminal to communicate in a wireless manner with the network 50. Typically, the terminal is based on the GSM or UMTS systems or local area network protocols for local connectivity such as IEEE 802.11. The user input device 34 can be a simple keypad, or it can be a more complex device such as a touch-sensitive tablet which is combined with the display 33, with context-sensitive labels and ‘soft buttons’ displayed on the display 33 under the control of microprocessor 31. The portable terminal 30 derives power from a battery (not shown) in the device. Control software resides on the memory 32 and controls operation of the microprocessor 31. Additional software can support applications which are also executed by the microprocessor 31. One of these applications is gaming software which is shown more fully in FIG. 3. Typically, the wireless connection between terminal 30 and network 50 is a Wireless Application Protocol (WAP) connection, although any suitable protocol can be used.

In FIG. 1, terminal 30 is a wireless terminal which communicates, via a wireless link 26, with a base station BTS of network 50. A terminal which uses a wireless connection provides the user with most flexibility, but terminals using a wired connection to network 50 could also be used, if desired. In a further alternative, a terminal 40 could form part of a local area network (LAN), such as a wireless LAN, at a premises 25 which accesses network 50 via a gateway 27. The wireless connection 28 can be of any suitable type, such as IEEE 802.1a/b/g or Bluetooth. The premises 25 could be the premises of the player, a public wireless access point (such as at an airport) or some other place which provides wireless or wired access to network 50.

In accordance with this invention, a player can use terminal 30, 40 to participate in the game supported by host 10. This allows a player to play the same game as they normally would on primary terminal 20 while away from terminal 20, such as while travelling to work, while on holiday, or any other occasion when the player is unable to use their normal terminal 20. The capabilities of terminal 30, 40 determine what gaming functions can be supported by terminal 30, 40. Some of the important capabilities of the terminal 30, 40 are: the size and type of display 33 and associated display driver (e.g. monochrome or colour, colour depth, resolution), the type of user input device (e.g. keypad, trackball, mouse, joystick), audio capabilities (e.g. simple beeps or polyphonic sound), processor type and performance, memory capacity and the type of network connection (e.g. bandwidth available).

It will be appreciated that certain functions of a game require the terminal to have a good quality display, a powerful processor and a user input device such as a trackball, mouse or joystick while other functions of a game can be achieved with a lower specification machine. Thus, the interaction between terminal 30, 40 and host 10 depends on the capabilities of terminal 30, 40.

Terminals 20, 22, 24, 30, 40 each run game software, the main functional blocks of which are shown in FIG. 3. Game software 60 is executed by processor 31, FIG. 2, and by similar processors within PCs and gaming platforms. The software 60 comprises two main functional blocks: the main gaming application 65 and a block 62 which is responsible for detecting the capabilities of the terminal on which it resides. The gaming application 65 and block 62 communicate with the host 10, via an interface to network 50, and with other parts of the terminal, via an interface 68. Game application 65 sends and receives game data 64, such as position vectors and various management information. Audio and graphical data is output via interface 68 and user inputs from a keyboard, joystick or other user-input device are received via interface 68. Block 62 gathers information about the capabilities of the terminal by sending and receiving messages via interface 68 and can exchange control messages 63 with the host 10 via the network interface.

There are various ways in which the host 10 can determine the capabilities of a terminal. Firstly, during an initial registration process, host 10 can interrogate terminal 30 to find out the capabilities of the terminal. Block 62 of the game software may already know the capabilities of the terminal or it may gather this information in response to being interrogated by the host. Terminal 30, 40 can signal its capabilities in an agreed format: this can include an agreed code representing the capabilities of each of the relevant features (display, user input device, audio, processor) or it can be a code which represents a terminal type, e.g. code 1=low-spec mobile phone, code 2=high-spec mobile phone, code 3=PDA etc. Knowing this information, host 10 can determine the capabilities of terminal 30, 40 and provide a range of gaming functionality which is appropriate.

In an alternate scheme, each terminal 20, 22, 24, 30, 40 has a particular version of gaming software 60 residing on it. For terminals 20, 22, 24 this will be a full-function version of the gaming software. In contrast, terminals 30, 40 have a cut-down version of the gaming software which is matched to the capabilities of terminal 30, 40. During an initial registration process, host 10 can interrogate terminal 30, 40 to determine what version of gaming software it is running. Knowing the software version being used by a terminal, and the minimum terminal capabilities required for that software version, host 10 can determine the capabilities of terminal 30, 40 and provide a range of functionality which is appropriate.

In a further alternative a benchmarking test or set of tests can be performed by the terminal. The benchmarking can be performed as part of the process of installing the gaming software on the terminal, with the benchmarking results being stored for later transmission to the host. Alternatively, the benchmarking may be performed at the request of the host as part of a registration process. The results of the benchmarking tests provide the host 10 with information about the capabilities of the terminal and can be used to determine what gaming features can be supported.

The process of interrogating a terminal can occur at the beginning of each gaming session or it may occur only during the first time that a player first registers terminal 30, 40 with host 10. Host 10 can be arranged to store the capabilities of terminal 30, 40 alongside an identifier of the terminal such that each time a player registers with the host, the host can retrieve the terminal capabilities and automatically provide an appropriate level of functionality. The identifier of a terminal can be the terminal ID code which is stored on the Subscriber Identity Module (SIM) of a mobile terminal, shown as ID card 38 in FIG. 2, or some other data which is stored on non-volatile memory as part of memory 32.

FIG. 4 shows the main functional blocks within host 10. These include a network interface 11, a processing system 12 for supporting the gaming environment and a storage device 15 for storing game data such as position and graphical information for the physical environment, characters and objects, and character data. Due to the quantity of data and the vast amount of real-time processing required, the processing system 12 and storage device 15 are each likely to be an array of high-performance devices, with suitable back-up devices. A further functional block 13 acts as an interface between terminals and the gaming application 16. Interface 13 includes a terminal capabilities determination unit 14. As previously described, this is responsible for determining the capabilities of terminals participating in the gaming environment and storing those capabilities and identities of terminals for later retrieval. The gaming application processed by the game processing unit 16 has a plurality of different functions (shown schematically as Function_A to Function_D), each function requiring a terminal to have a minimum set of capabilities for the function to be supported by the terminal. Unit 14 includes a store of these functions and minimum capabilities, shown as table 18, and uses this store to determine what functions are available to a terminal when a terminal registers with the host. The interface 13 outputs a control signal 19 to the game processing unit 16 which instructs unit 16 which of the gaming functions should be provided to each terminal.

FIG. 5 shows a flow chart of a terminal registration process at the beginning of a gaming session, showing the steps performed by the host 10. Firstly, at step 100, terminal 30, 40 initiates a connection with the host 10. At step 102 the host requests the player to identify themselves by entering a username and password. Upon receiving these, the host preferably checks whether a player with those details has already logged on. If so, the new log on attempt may represent an abuse of the system and steps can be taken to deal with this, such as by denying the new connection. The host then requests, at step 104, the identity of the terminal, such as the identity stored in the SIM 38. The retrieved terminal ID is compared with stored data in unit 14, FIG. 4, at step 106. If the retrieved terminal ID matches one that has been stored, then previously stored capability information can be retrieved at step 108. However, if the terminal ID is not recognised, the host interrogates the terminal to determine its capabilities at step 110, as previously described. Upon retrieving or receiving the terminal capabilities, the host selects an appropriate level of functionality for all future interactions with the terminal. Typically, if the terminal has lower capabilities than a standard gaming platform, this will mean that the host will only allow the terminal to access management functions of the game and will not send any graphically-intensive data. If the terminal was not previously known to the host, the host stores the capability information and terminal ID for future sessions in unit 14.

In the above description, terminal 30, 40 is used to allow a player to participate in the game while away from their normal terminal 20. Referring again to FIG. 1, terminal 40 can be used in a second way. Terminal 40 is used to provide a second, lower-functionality access to the gaming environment. Terminal 40 can be used by a second player, or ‘co-pilot’, to simultaneously access the first player's game data. Using terminal 40, the co-pilot can perform management functions of the game while the main player controls a characters movement in the gaming environment. When a second player is registered, the restricted set of functions that are available to terminal 40 can be removed from the set of functions available to the terminal 20 of the main player, e.g. where the second player has access to management functions, the main player is able to control a characters movement but is unable to access the management functions. This has an advantage in that it prevents conflicting instructions being made by the main and second players. Referring again to FIG. 3, block 62 of the game software within terminal 20 receives a control message indicating what functions are now available to the terminal, and this is passed on to the main game application 65. As an example, the terminal may initially have sufficient capabilities to support all of Functions A to D but, in response to a second player being assigned Function D, the terminal receives a control message indicating that Function D is suspended on the terminal. Terminal 40 forms part of a local area network (LAN), such as a wireless LAN, at the premises 25 of the player of terminal 24. The wireless connection can be of any suitable type, such as IEEE 802.11a/b (WiFi) or Bluetooth. It can also be a direct connection to network 50, such as a WAP connection, in the same manner as terminal 30.

FIG. 6 shows part of the terminal registration process at a host in a system which allows multiple terminals to access the same player data. Typically, the steps shown in FIG. 6 will be performed together with the registration process previously shown in FIG. 5. The difference is that two users are allowed to access the same user data. Preferably, a player's profile at unit 14 include details of whether the player has subscribed to this two-terminal service. Firstly, at step 120, it is determined whether a user is already connected. The main player may already be connected at the time that a second player decides to join in. If another player is not already connected, the registration process of FIG. 5 can continue as normal, at step 122. However, if another player is already connected then both the new player and the existing player are notified of this and are asked to confirm that they are happy to proceed to two-player operation at step 124. If, at step 126, both players do not agree, then the new connection is denied and the previous connection is maintained. If, at step 126, both players do agree, then the new connection is allowed and the set of game functions which have previously been made available to the first player are distributed between both players according to the capabilities of the terminals that those players are using. Typically, at step 130, the main platform loses control of certain management functions while, at step 132, the limited capability platform gains control of these functions.

In the above description, a role-playing game has been used as an example of a network based game. However, the invention is not restricted to use with these games. In strategy games there are management activities between battles which can be performed by terminals having limited capabilities. Also, simulation games such as the SIM™ series, flight simulators (such as combat flight simulators) and racing games all have a range of features which can be accessed by terminals of lower capabilities in a similar way.

The following description is a scenario of how the above system may be used. A user plays ‘The Game’ online at home using her PC 20. She is in a party with several other users but now has to retire to bed as it is late. She takes her character in ‘The Game’ to ‘The Inn’ in ‘The Town’ and exits the game. ‘The Inn’ is a safe-haven where characters can safely reside when a player is unable to play the game using their terminal 20.

The next day, on the train to work, the player uses her mobile phone (terminal 30) to connect to the host 10 of ‘The Game’ and retrieves her character information. As she quit ‘The Game’ last night whilst in a designated trading area she is able to advertise her ‘Powerful Item’ to the other occupants of ‘The Inn’ (several thousand of them!) She is wishing to raise either in-game currency in order to buy items to heal her character or real-life currency in order to extend her subscription to ‘The Game’ and has a duplicate ‘Powerful Item’ and so can afford to let one go. As she is also in a designated chat area she can view other logged in users who are currently occupying ‘The Inn’ and chat to them. Using her mobile phone she can either speak, with the host translating speech to text, or use text messaging. While the player is here she recalls that she has a left over experience point to spend and has a choice of two spells to upgrade with it. Able to access in game information about the spells, she finally decides on one and assigns her last point to it. In general, the player is able to access features of the game that are normally only used during quiet periods, such as viewing and managing her character's inventory, trading with other real player characters or members of her party, viewing and modifying her character statistics and attributes, viewing her spell book or planning strategies for approaching the next quest. During the time that her character is in the dedicated safe area of ‘The Inn’ she is safe from harm.

The players train is now close to the station and so she just has time to leave a message for her fellow party members to meet her tonight at ‘The Town’ gate before logging off and going to work. During the time that her character is in ‘The Inn’ the player is unable to control her character to leave ‘The Inn’ in the usual way as her phone has an unsuitable display and processor to render the game's normal graphical environment. That night the player's friend visits whilst she is mid game. Her friend is also a fan and wishes to help the player. Her friend can access management functions of the character via her own phone, whilst the player continues to play the game normally via her PC. This combination allows the player to fight whilst her friend dynamically changes her equipment to suit the situation, using healing or statistic enhancing items and casting spells etc.

In the description above, and with reference to the Figures, there is described a gaming system in which terminals 20, 22, 24, 30, 40 of players connect with a host 10 of a gaming application via a network 50. Terminals can be of different types and have different capabilities. The host 10 comprises processing means for supporting a gaming application and an interface 13, FIG. 4. The interface 13 determines the capabilities of a terminal being used by a player and provides the terminal with a range of interaction with the gaming application which is matched to the determined capabilities of the terminal. The gaming application can be a multi-player gaming application such as a massively multiplayer online role playing game (MMORPG). Terminals having limited capabilities are provided with access to limited gaming functions, such as management functions. Two terminals may simultaneously access the same player's data, with a terminal of lower capabilities being used by a co-pilot.

1. An interface for a host (10) of a gaming system in which terminals (20, 22, 24, 30, 40) of players connect with the host (10) via a network (50), the host (10) comprising processing means (16) for supporting a gaming application, the interface being arranged to:
determine the capabilities of a terminal (20, 22, 24, 30, 40) being used by a player; and,
provide the terminal (20, 22, 24, 30, 40) with a range of interaction with the gaming application according to the determined capabilities of the terminal.

2. An interface according to claim 1 wherein the gaming application has a plurality of different functions, each function requiring a terminal (20, 22, 24, 30, 40) to have a minimum set of capabilities for the function to be supported by the terminal, and wherein the interface has a store (14) of the functions and the minimum set of capabilities for each function.

3. An interface according to claim 1 which is arranged to determine the capabilities of a terminal (20, 22, 24, 30, 40) by issuing a request, via the network (50), for information about the capabilities of the terminal.

4. An interface according to claim 1 which is arranged to determine the capabilities of a terminal (20, 22, 24, 30, 40) by determining which software version a terminal is running.

5. An interface according to claim 1 which is arranged to determine the capabilities of a terminal (20, 22, 24, 30, 40) by determining at least one of the following capabilities of the terminal: size of display, resolution of display, colour depth of display, display driver capabilities, user input devices, audio capabilities, processor type, memory and network connection.

6. An interface according to claim 1 which is arranged to determine the capabilities of a terminal (20, 22, 24, 30, 40) by requesting the terminal to send a profile representative of the type of terminal.

7. An interface according to claim 1 which is arranged to determine the capabilities of a terminal (20, 22, 24, 30, 40) by receiving the results of a benchmark test performed by the terminal.

8. An interface according to claim 1 which is arranged to store (14) the capabilities of a terminal and an identifier of the terminal for use during future occasions that the terminal registers with the host.

9. An interface according to claim 1 wherein the gaming application has management functions and character movement functions and wherein, if the interface determines that a terminal has limited capabilities, the interface only provides the terminal with access to the management functions of the game.

10. An interface according to claim 1 wherein the gaming application is a multi-player gaming application in which terminals of a plurality of players are simultaneously interconnected via the network.

11. An interface according to claim 1 wherein the gaming application is a role-playing game.

12. An interface according to claim 1 wherein the host further comprises a store of player-related information (15) and wherein the interface is arranged to allow a first terminal and a second terminal to simultaneously access a single player's information.

13. An interface according to claim 12 which is arranged to request confirmation from at least the first terminal, representing an already connected player, before granting a second terminal simultaneous access to the same player data.

14. An interface according to claim 12 which is arranged to divide an overall range of gaming functions between the first terminal and second terminal according to the capabilities of those terminals.

15. An interface according to claim 14 which is arranged to provide management functions of a game to a terminal of limited capabilities and other functions of the game to a terminal of greater capabilities.

16. Software for controlling operation of an interface of a host (10) of a gaming system in which terminals (20, 22, 24, 30, 40) of players connect with the host (10) via a network (50), the host comprising processing means (16) for supporting a gaming application, the software being arranged to cause a processing entity of the host to perform the functions of:
determining the capabilities of a terminal (20, 22, 24, 30, 40) being used by a player; and,
providing the terminal (20, 22, 24, 30, 40) with a range of interaction with the gaming application according to the determined capabilities of the terminal.

17. A host for a gaming system comprising the interface according to claim 1.

18. A gaming system comprising the host according to claim 16.

19. A method of providing a gaming service to a player in a gaming system in which terminals of players connect with a host (10) via a network (50), the host (10) supporting a gaming application, wherein the method comprises:
determining the capabilities of a terminal (20, 22, 24, 30, 40) being used by a player; and
providing a terminal (20, 22, 24, 30, 40) with a range of interaction with the gaming application according to the determined capabilities of the terminal.

20. Software for controlling operation of a terminal to allow the terminal to interact with a host (10) of a gaming system via a network (50), the host supporting a gaming application, the software being arranged to cause a processing entity of the terminal to perform the functions of:
determining the capabilities of the terminal (20, 22, 24, 30, 40);
sending information about the determined capabilities to the host; and,
receiving a range of interaction with the gaming application according to the capabilities of the terminal.
